(19) United States
(12) Patent Application Publication
(10) Pub. No.: US 2008/0151839 A1
(43) Pub. Date: Jun. 26, 2008

(54) Frequency Synchronization During Cell Search in a Universal Mobile Telephone System Receiver

(76) Inventors: Louis Robert Litwin, Plainsboro, NJ (US); Wen Gao, Plainsboro, NJ (US)

Correspondence Address: Joseph J. Laks;Thomson Licensing LLC, 2 Independence Way, Patent Operations, PO Box 5312, PRINCETON, NJ, 08543, US

(21) Appl. No.: 10/566,876

(22) PCT Filed: Aug. 4, 2003
(86) PCT No.: PCT/US03/24358

§ 371 Date: Feb. 2, 2006

(51) Int. Cl. H04J 3/06

(52) U.S. Cl. 370/336

(57) ABSTRACT

A Universal Mobile Telephone System (UMTS) receiver performs slot synchronization using a received primary synchronization channel (PSCH) (305). Subsequent to completion of slot synchronization, the UMTS receiver performs frame synchronization using a received secondary synchronization channel (SSCH) (320) in such a way that the UMTS receiver uses the received primary synchronization channel (PSCH) to adjust for the presence of frequency offset (325, 330, 335).

### BACKGROUND OF THE INVENTION

The present invention generally relates to wireless receiving devices, and more particularly, to user equipment (UE) in a spread-spectrum based wireless system such as the Universal Mobile Telephone System (UMTS).

The basic unit of time in UMTS radio signals is a 10 milli-second (ms) radio frame, which is divided into 15 slots of 2560 chips each. UMTS radio signals from a cell (or base station) to a UMTS receiver are “downlink signals,” while radio signals in the reverse direction are termed “uplink signals.” When a UMTS receiver is first turned on, the UMTS receiver performs a “cell search” to search for a cell to communicate with. In particular, and as described below, the UMTS receiver initially looks for a downlink synchronization channel (SCM) transmitted from the cell to synchronize thereto at the slot and frame levels, and to determine the particular scrambling code group of the cell. Only after a successful cell search can voice/data communications begin.

With respect to the cell search, the SCH is a sparse downlink channel that is only active during the first 256 chips of each slot. The SCH is made up of two subchannels, the Primary SCH (PSCH) and the Secondary SCH (SSCH). The PSCH 256 chip sequence, or PSCH code, is the same in all slots of the SCH for all cells. In contrast, the SSCH 256 chip sequence, or SSCH code, may be different in each of the 15 slots of a radio frame and is used to identify one of 64 possible scrambling code groups. In other words, each radio frame of the SCH repeats a scrambling code group sequence associated with the respective transmitting cell. Each SSCH code is taken from an alphabet of 16 possible SSCH codes.

As part of the cell search, the UMTS receiver first uses the PSCH to achieve slot synchronization. In this regard, the UMTS receiver correlates received samples of the received PSCH against the known PSCH 256 chip sequence (which is the same for all slots) and, based on the location of the correlation peak, determines a slot reference time. Once the slot reference time is determined, the UMTS receiver is slot synchronized and can determine when each slot starts in a received radio frame.

After slot synchronization, the UMTS receiver ceases processing of the PSCH and begins processing the SSCH. In particular, the UMTS receiver correlates the particular sequence of 15 SSCH codes in a received radio frame against known sequences to achieve frame synchronization and to determine the scrambling code group of the cell. Identification of the scrambling code group then enables the UMTS receiver to descramble all of the other downlink channels of the cell (e.g., the Common Pilot Channel (CPICH)) for voice/data communications to begin.

Unfortunately, the above-described cell search process has some drawbacks. One is time. Since SSCH processing involves the identification of a sequence of 15 particular SSCH codes, the SSCH code processing typically occurs over a number of received radio frames, e.g., 10 to 20. Therefore, completion of the cell search may take on the order of 100 to 200 ms. Another drawback is that the UMTS receiver does not achieve frequency synchronization until the CPICH is descrambled, which, as noted above, occurs after successful completion of the above-mentioned cell search. As such, frequency offsets between the cell and the UMTS receiver can degrade the performance of the SSCH processing during the cell search (e.g., a correlation peak might not stand out very far from the background noise). Such frequency offsets occur, e.g., because of the lower accuracy of the reference oscillator in the UMTS receiver used for down conversion. In addition, any frequency offset effects may also be further compounded by Doppler effects if the UMTS receiver is mobile. Consequently, frequency offsets may further lengthen the time required for the UMTS receiver to perform the SSCH processing portion of the cell search—especially if such frequency offsets cause the SSCH processing to restart.

### SUMMARY OF THE INVENTION

Therefore, and in accordance with the principles of the invention, a wireless receiver performs slot synchronization using a received first synchronization channel, and, subsequent to completion of slot synchronization, performs frame synchronization using a received second synchronization channel in such a way that the received first synchronization channel is now used by the wireless receiver to adjust for frequency offset. Thus, the effect of frequency offset on the process of frame synchronization is reduced, if not eliminated.

In an embodiment of the invention, the wireless receiver is a part of the UMTS user equipment (UE), the first synchronization channel is the PSCH subchannel and the second synchronization channel is the SSCH subchannel. The wireless receiver continues to process the PSCH during SSCH processing to adjust for frequency offset. In particular, frequency adjustment is performed by correlating against the PSCH code after rotating received samples of the PSCH by different frequency offsets. The frequency offset that corresponds to the highest correlation peak is used as an estimate of the actual frequency offset between the cell and the wireless receiver.

In accordance with another aspect of the invention, the wireless receiver continues to process the PSCH during SSCH processing to successively approximate the frequency offset. For example, first a coarse estimate of frequency offset is determined by adjusting estimates of the frequency offset with large frequency steps (or coarse steps), e.g., in increments of 2.5 kHz. After the coarse estimate of frequency offset has been determined, a final estimate of frequency offset is determined by further adjusting the coarse estimate of frequency offset using smaller steps (or fine steps), e.g., in increments of 1.25 kHz, then 0.625 kHz, etc.

### BRIEF DESCRIPTION OF THE DRAWINGS

FIG. 1 shows a portion of an illustrative wireless communications system in accordance with the principles of the invention;

FIGS. 2 and 3 show illustrative embodiments of a wireless receiver in accordance with the principles of the invention; and

FIGS. 4, 5 and 6 show illustrative flow charts in accordance with the principles of the invention.

### DETAILED DESCRIPTION

Other than the inventive concept, the elements shown in the figures are well known and will not be described in detail. Also, familiarity with UMTS-based wireless communications systems is assumed and is not described in detail herein. For example, other than the inventive concept, spread spectrum transmission and reception, cells (base stations), user equipment (UE), downlink channels, uplink channels and RAKE receivers are well known and not described herein. In addition, the inventive concept may be implemented using conventional programming techniques, which, as such, will not be described herein. Finally, like-numbers on the figures represent similar elements.

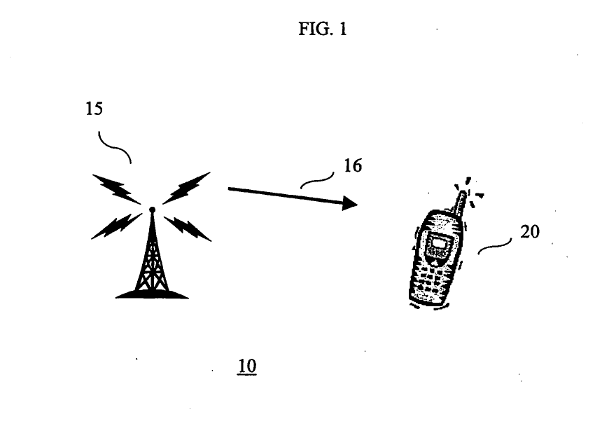

An illustrative portion of a UMTS wireless communications system 10 in accordance with the principles of the invention is shown in FIG. 1. Cell (or base station) 15 broadcasts a downlink synchronization channel (SCH) signal 16 including the above-mentioned PSCH and SSCH subchannels. As noted earlier, the SCH signal 16 is used by UMTS User Equipment (UE) for synchronization purposes as a pre-condition to voice/data communications. For example, the UE processes the SCH signal during a “cell search” operation. In this example, UE 20, e.g., a cellular phone, initiates a cell search when, e.g., UE 20 is turned on, or powered up. The purposes of the cell search operation include: (a) synchronization to cell transmissions at the slot and frame level of the UMTS radio frame, and (b) determination of the scrambling code group of the cell (e.g., cell 15). As described below, and in accordance with the principles of the invention, UE 20 processes the SSCH subchannel to achieve frame synchronization with cell 15 while using the PSCH subchannel to adjust for frequency offset. It should be noted that although the following examples illustrate the inventive concept in the context of this initial cell search, i.e., when UE 20 is turned on, the inventive concept is not so limited and is applicable to other instances of the cell search, e.g., when the UE is in an “idle mode.”

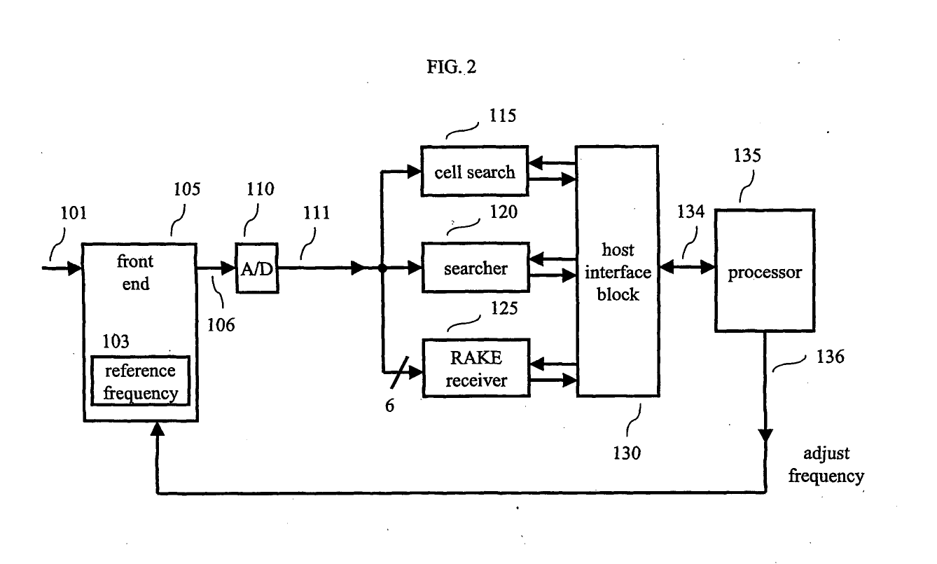

Turning now to FIG. 2, an illustrative block diagram of a portion of UE 20 in accordance with the principles of the invention is shown. UE 20 includes front end 105, analog-to-digital (A/D) converter 110, cell search element 115, searcher element 120, rake receiver 125, host interface block 130 and processor 135. It should also be noted that, other than the inventive concept, additional elements may be included within the blocks shown in FIG. 2 as known in the art but are not described herein for simplicity. For example, A/D converter 110 may include digital filters, buffers, etc.

Front end 105 receives a radio-frequency (RF) signal 101 transmitted from cell 15 (FIG. 1) via an antenna (not shown) and provides a base band analog signal 106 representing the PSCH and SSCH subchannels. Front end 105 includes a reference frequency source 103 for use in processing RF signal 101 to provide the base band analog signal 106. The latter is sampled by A/D converter 110, which provides a stream of received samples 111. The received samples 111 are available to three components: cell search element 115, searcher element 120 and rake receiver 125. Cell search element 115 processes the PSCH and SSCH subchannels in accordance with the principles of the invention as described further below. Subsequent to a successful cell search, searcher element 120 evaluates the received samples for the assignment of multipaths to each of the fingers of rake receiver 125, which, e.g., is capable of combining data from multiple paths in providing symbols for subsequent decoding by a decoder (not shown) to provide voice/data communications. Since only cell search element 115 is relevant to the inventive concept, search component 120 and rake receiver 125 are not described further herein. Host interface block 130 couples data between the three aforementioned components and processor 135, which, in this context, receives the results from cell search component 115 via signaling 134. Processor 135 is illustratively a stored-program controller processor, e.g., a microprocessor and includes memory (not shown) for storing programs and data.

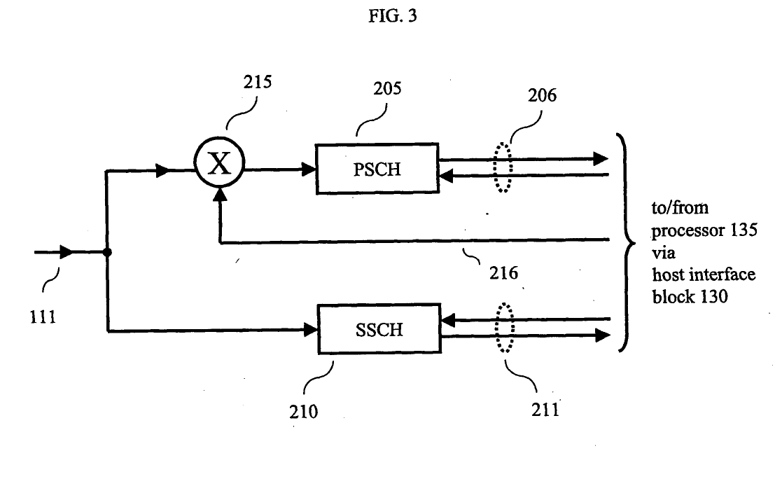

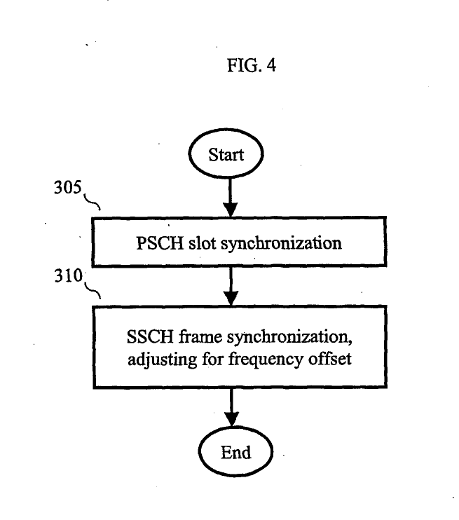

Turning now to FIG. 3, an illustrative block diagram of cell search element 115 is shown. Cell search element 115 includes PSCH element 205, SSCH element 210 and rotator 215. Reference should now also be made to FIG. 4, which shows an illustrative flow chart in accordance with the principles of the invention for processing the downlink PSCH and SSCH subchannels with cell search element 115 of FIG. 3. Processor 135 of UE 20 initiates the cell search in step 305 attempting to achieve slot synchronization by processing the downlink PSCH subchannel in step 305. In particular, processor 135 activates PSCH element 205, via signaling 206, to process the received samples 111. In addition, processor 135 controls rotator 215 via signaling 216 to, at this time, provide zero rotation of the received samples 111, i.e., received samples 111 pass through rotator 215 with no rotation—as if rotator 215 was not present. In step 305, the received samples 111 are processed by PSCH element 205 as known in the art. For example, since the downlink PSCH subchannel is a known PSCH 256 chip sequence, or PSCH code, that occurs periodically (i.e., repeats in every slot of the downlink SCH signal), PSCH element 205 correlates the received samples 111 against the PSCH code and provides an associated peak correlation value. In this regard, PSCH element 205 comprises a matched filter and a buffer (both not shown) that stores the output signal of the matched filter. PSCH element 205 provides a peak value to processor 135 via signaling 206. This peak value may be averaged over several slots of a received radio frame(s), e.g., between four and twenty slots, to decrease the probability of a “false lock.” If the peak value is not greater than a predefined threshold, processor 135 controls PSCH element 305 to continue processing any received signals to continue to look for a cell. However, if the peak value is greater than a predefined threshold, UE 20 completes slot synchronization and processor 135 continues the cell search process with respect to flame synchronization and determining the particular scrambling code group for the associated cell. An alternative method is to deem slot synchronization complete when the peak correlation value exceeds the next highest correlation value by a predefined additive or multiplicative factor.

In particular, in step 310, and in accordance with the principles of the invention, processor 135 enables both SSCH element 210 and PSCH element 205. The former processes the received samples 111 as known in the art. The latter is used to determine an estimate of frequency offset, which processor 135 uses to adjust reference frequency 103 via signaling 136 of FIG. 2 to compensate for frequency offset during SSCH processing. Thus, the effect of frequency offset on the process of frame synchronization is reduced, if not eliminated.

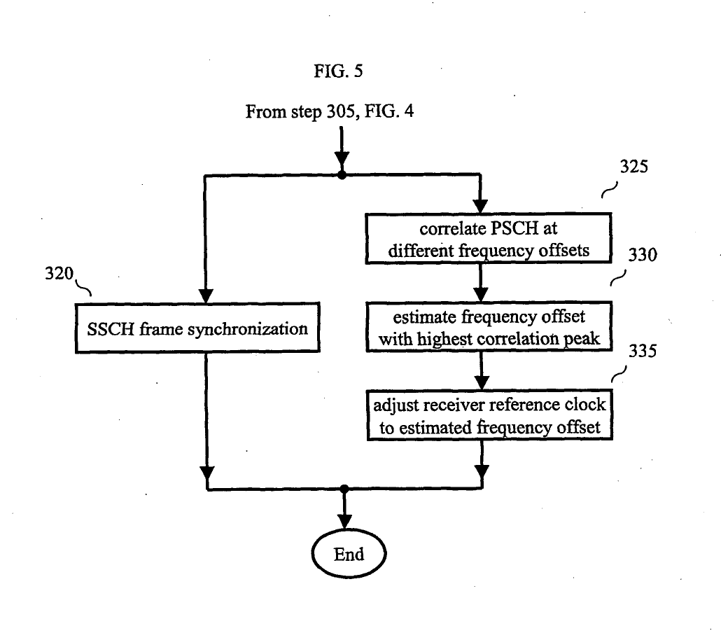

Turning now to FIG. 5, step 310 of FIG. 4 is shown in more detail. Illustratively, step 310 includes step 320, which is related to SSCH processing, and steps 325, 330 and 335, which relate to estimating frequency offset. Step 320 corresponds to SSCH processing as known in the art and is illustratively performed by SSCH element 210 and processor 135 of FIGS. 2 and 3, respectively. SSCH element 210 is coupled with processor 135 via signaling 211. As noted above, the SSCH 256 chip sequence, or SSCH code, is different in each of the 15 slots of a radio frame for a particular cell. As such, each radio frame repeats a unique 15 SSCH code associated with a particular cell. Once activated by processor 135, SSCH element 210 correlates the particular sequence of 15 SSCH codes in a received radio frame against known sequences for use in achieving frame synchronization and for use in determining the scrambling code group of the cell (here, the scrambling code group associated with cell 15). As noted above, the SSCH processing may require processing a number of received radio frames, e.g., 10 to 20. During this processing, PSCH element 205 is used by processor 135 to estimate frequency offset between cell 15 and UE 20.

In particular, in step 325, processor 135 adjusts rotator 215 to provide received samples 111 to PSCH element 205 at varying rotations. The use and placement of rotator 215 as shown in FIG. 3 prevents the various rotations from affecting the SSCH processing. For example, instead of directly adjusting reference frequency 103 of FIG. 2 in searching for the frequency offset, received samples 111 are multiplied by a complex number that is rotating at the desired frequency before application to PSCH element 205. As such, and as can be observed from FIG. 3, this multiplication, or rotation, only affects the samples processed by PSCH element 205 and not the samples processed by SSCH element 210. However, the use and placement of rotator 215 is merely illustrative and the inventive concept is not so limited. For example, all of the received samples could be rotated notwithstanding the effect on SSCH processing.

Returning to FIG. 5, assume that based on the accuracy of the local receiver oscillator of the UE, it is known a priori that the frequency offset between the UE and the cell can be as large as ±10 kHz. As such, step 325 is executed to repetitively step through rotation values, i.e., frequency offsets, of 0, ±0.25, ±0.5, ±0.75, ±1.00, . . . ±10.0 kHz. For each rotation value, PSCH element 205 correlates the rotated received samples to the known PSCH code and provides the associated correlation peak values to processor 135, via signaling 206. Processor 135 keeps track of the size of the correlation peaks that result from the various rotation settings. Without the rotation, any actual frequency offset between cell 15 and UE 20 will result in a lower correlation peak for the PSCH code than the correlation peak that would result from a zero frequency offset between cell 15 and UE 20. Thus, as received samples 111 are rotated, the rotation value associated with the largest correlation peak is an estimate of the actual frequency offset between cell 15 and UE 20. In step 330, processor 135 examines all of the correlation peaks and determines the largest correlation peak along with the associated rotation value, which is representative of an estimate of the frequency offset. In step 335, processor 135 accordingly adjusts the local reference, e.g., reference frequency 103 of FIG. 2, by the associated rotation value. It should be noted that although FIG. 5 illustrates compensating for a frequency offset in the context of a single pass through steps 325, 330 and 335, the invention is not so limited and, e.g., steps 325, 330 and 335 may be repeated a number of times during SSCH processing. Once SSCH processing is completed in step 320, the scrambling code group of cell 15 is identified which enables UE 20 to descramble all of the other downlink channels of the cell (including, e.g., the Common Pilot Channel (CPICH), which is used for frequency synchronization and also to determine the actual scrambling code for the cell from the identified scrambling code group) and voice/data communications can begin.

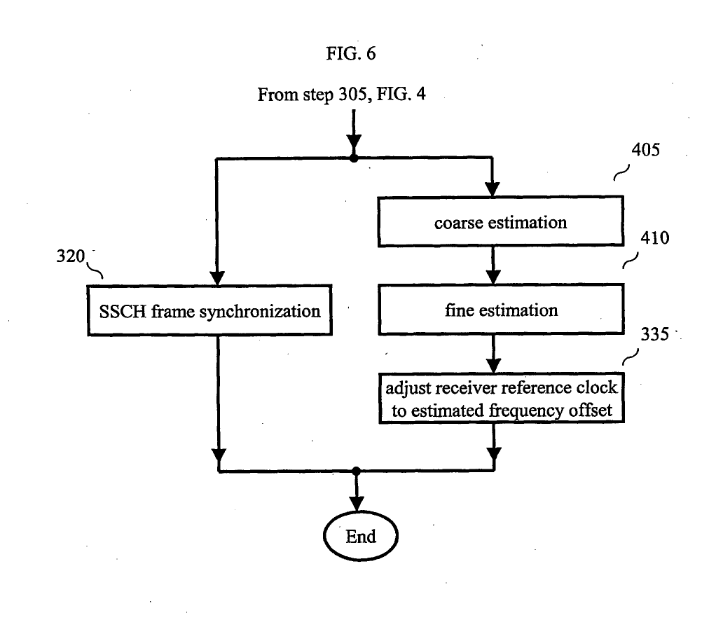

In addition, the above-described processing can be performed as shown in FIG. 6, which is similar to the flow chart of FIG. 5. As can be observed from FIG. 6, there is more than one level of processing as represented by coarse estimation step 405 and fine estimation step 410. Each of the steps 405 and 410 includes processing similar to that shown in steps 325 and 330 of FIG. 5 for providing an estimate of frequency offset. Similarly, either step 405 or step 410, or both steps 405 and 410 may be repeated a number of times during SSCH processing. With respect to FIG. 6, consider the following example. Again, assume that based on the accuracy of the local receiver oscillator, it is known a priori that the frequency offset between the UE and the cell can be as large as ±10 kHz. As such, step 405 is executed to first determine a coarse estimate of frequency offset. For example, processor 135 executes the PSCH processing using large frequency steps, e.g., steps of 2.5 kHz resulting in frequency offsets of 0, ±2.5, ±5, ±7.5 kHz for rotator 215. Then, step 410 further refines the resulting coarse estimate of the frequency offset by using smaller steps. For example, assume that after step 405 the coarse estimate of the frequency offset associated with the largest peak is 5 kHz. Processor 135 then executes, in step 410, the PSCH processing using small frequency steps, e.g., steps of 0.25 kHz resulting in frequency offsets of 5, 5±0.25, 5±0.5, and 5±0.75 kHz for rotator 215 for determining an estimate of the frequency offset as described above. Once an estimate of the frequency offset is determined, processor 135 accordingly adjusts the local reference, e.g., reference frequency 103 of FIG. 2, with the estimated frequency offset in step 335. In effect, the PSCH processing is used to successively approximate the frequency offset during the SSCH processing.

As described above, and in accordance with the principles of the invention, the PSCH subchannel is used during processing of the SSCH subchannel in a way that enables the wireless receiver to achieve at least a coarse frequency synchronization before the SSCH processing is complete. As such, this approach may improve the performance of the SSCH processing in the presence of a frequency offset. Although described in the context of the initial cell search process, the inventive concept is applicable to any portion of wireless operation in which a downlink channel, such as the SSCH subchannel, is processed in the presence of frequency offset.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs) and/or in one or more stored program-controlled processors (e.g., a microprocessor or digital signal processor (DSP)). Similarly, although illustrated in the context of a UMTS-based system, the inventive concept is applicable to any communications system that processes signals in the presence of frequency offset. It is therefore to be understood that numerous modifications may be made to the illustrative embodiments and that other arrangements may be devised without departing from the spirit and scope of the present invention as defined by the appended claims.

1. A method for use in a wireless receiver, comprising:
receiving a wireless signal;
processing a first synchronization channel (305) of the received wireless signal to acquire slot synchronization; and
processing a second synchronization channel of the received wireless signal to acquire frame synchronization in such a way that the first synchronization channel is used to adjust for a frequency offset (310).

2. The method of claim 1, wherein the first synchronization channel is a primary synchronization subchannel (PSCH) and the second synchronization channel is a secondary synchronization subchannel (SSCH) of a universal mobile telephone system (UMTS).

3. The method of claim 1, wherein the step of processing a second synchronization channel includes the steps of:
processing the first synchronization channel to estimate a frequency offset in the received wireless signal; and
adjusting a clock of the wireless receiver to compensate for the estimated frequency offset.

4. The method of claim 3, wherein the step of processing the first synchronization channel to estimate a frequency offset includes:
rotating signals associated with the first synchronization channel through a plurality of frequency offsets;
determining a corresponding plurality of correlation peaks for each of the rotated signals at each of the plurality of frequency offsets;
selecting at least one of the plurality of correlation peaks such that a magnitude of the selected correlation peak is at least as large as magnitudes of the remaining plurality of correlation peaks; and
using at least the corresponding one of the plurality of frequency offsets associated with the selected correlation peak as the estimated frequency offset.

5. The method of claim 1, wherein the step of processing a second synchronization channel includes the steps of:
processing the first synchronization channel to provide a coarse estimate of the frequency offset in the received wireless signal;
processing the first synchronization channel to further refine the coarse estimate of the frequency offset to provide a final estimate of frequency offset; and
adjusting a clock of the wireless receiver to compensate for the final estimate of the frequency offset.

6. A method for use in a Universal Mobile Telephone System (UMTS) based wireless receiver, comprising:
acquiring slot synchronization from a primary synchronization signal of a received wireless signal; and
after acquiring slot synchronization, using the primary synchronization signal to adjust for a frequency offset while acquiring frame synchronization from a secondary synchronization signal of the received wireless signal.

7. The method of claim 6, wherein the step of using the primary synchronization signal includes the steps of:
processing the primary synchronization signal to estimate a frequency offset in the received wireless signal; and
adjusting a clock of the wireless receiver to compensate for the estimated frequency offset.

8. The method of claim 7, wherein the step of processing the primary synchronization signal to estimate a frequency offset includes:
rotating signals associated with the primary synchronization signal through a plurality of frequency offsets;
determining a corresponding plurality of correlation peaks for each of the rotated signals at each of the plurality of frequency offsets;
selecting at least one of the plurality of correlation peaks such that a magnitude of the selected correlation peak is at least as large as magnitudes of the remaining plurality of correlation peaks; and
using at least the corresponding one of the plurality of frequency offsets associated with the selected correlation peak as the estimated frequency offset.

9. The method of claim 6, wherein the step of using the primary synchronization signal includes the steps of:
processing the primary synchronization signal to provide a coarse estimate of the frequency offset in the received wireless signal;
processing the primary synchronization signal to further refine the coarse estimate of the frequency offset to provide a final estimate of the frequency offset; and
adjusting a clock of the wireless receiver to compensate for the final estimate of the frequency offset.

10. Wireless equipment comprising:
a front end (105) for receiving a wireless signal and for providing a stream of received samples;
a primary synchronization element (205) operative on the received samples for acquiring slot synchronization to a primary synchronization signal of the received wireless signal and for further processing the primary synchronization signal subsequent to slot synchronization for estimating frequency offset;
a secondary synchronization element (210) operative on the received samples for acquiring frame synchronization to a secondary synchronization signal of the received wireless signal; and
a processor (135), responsive to the further processing of the primary synchronization signal by the primary synchronization element, to adjust for a frequency offset in the wireless equipment during operation of the secondary synchronization element.

11. The wireless equipment of claim 10, wherein, subsequent to slot synchronization, the primary synchronization element continues to process the primary synchronization signal of the received wireless signal simultaneously with processing of the received wireless signal by the secondary synchronization element.

12. The wireless equipment of claim 10, wherein the primary synchronization element determines an estimate of the frequency offset in the received wireless signal and the processor adjusts a clock of the wireless equipment to compensate for the estimated frequency offset.

13. The wireless equipment of claim 10, further including a rotator (215) for rotating the received samples while the secondary synchronization element is acquiring frame synchronization and for applying the rotated received samples to the primary synchronization element, which processes the primary synchronization signal represented therein.

14. The wireless equipment of claim 13, wherein the processor selects a rotation value of the rotator for use as the estimated frequency offset.
